(19) United States
(12) Patent Application Publication
(10) Pub. No.: US 2015/0242875 A1
(43) Pub. Date: Aug. 27, 2015

(54) COMMUNITY-POWERED SHARED REVENUE PROGRAM

(71) Applicant: FlipClip Global, Inc., Orinda, CA (US)

(72) Inventor: Barbara Carey Stachowski, Orinda, CA (US)

(21) Appl. No.: 14/634,595

(22) Filed: Feb. 27, 2015

Related U.S. Application Data
(60) Provisional application No. 61/945,713, filed on Feb. 27, 2014.

(51) Int. Cl. G06Q 30/02; G06F 17/22; G06F 17/30

(52) U.S. Cl. CPC G06Q 30/0214; G06F 17/30893; G06F 17/2235; G06F 17/30864

(57) ABSTRACT

A community-powered shared revenue program enables users to share product information, so that when the product is purchased, those who shared the product information leading to the sale will be rewarded with a percentage of the sale.

### CROSS-REFERENCE TO RELATED APPLICATION(S)

This application claims the benefit of U.S. Provisional Patent Application Ser. No. 61/945,713, filed Feb. 27, 2014, and titled “COMMUNITY-POWERED SHARED REVENUE PROGRAM,” which is hereby incorporated by reference in its entirety for all purposes.

### FIELD OF THE INVENTION

The present invention is in the technical field of electronic commerce. More particularly, the present invention is in the technical field of revenue sharing programs used for electronic commerce.

### BACKGROUND OF THE INVENTION

Amazon.com (U.S. Pat. No. 6,029,141) discloses an Internet-based referral system that enables individuals and other business entities (“associates”) to market products, in return for a commission, that are sold from a merchant's Web site. The system includes automated registration software that runs on the merchant's Web site to allow entities to register as associates. Following registration, the associate sets up a Web site (or other information dissemination system) to distribute hypertextual catalog documents that includes marketing information (product reviews, recommendations, etc.) about selected products of the merchant. In association with each such product, the catalog document includes a hypertextual “referral link” that allows a user (“customer”) to link to the merchant's site and purchase the product. When a customer selects a referral link, the customer's computer transmits unique IDs of the selected product and of the associate to the merchant's site, allowing the merchant to identify the product and the referring associate. If the customer subsequently purchases the product from the merchant's site, a commission is automatically credited to an account of the referring associate. The merchant site also implements an electronic shopping cart that allows the customer to select products from multiple different Web sites, and then perform a single “check out” from the merchant's site.

Essociate, Inc. (U.S. Pat. No. 6,804,660) discloses a method, system and computer program for affording Virtual Affiliates access to an existing affiliate system. First, having been assigned a unique identifier within a source affiliate system, a Webmaster operates a web site. Next, a request for a target Merchant Web site triggers a correlation function, such that the source Webmaster unique identifier is correlated to a target Webmaster unique identifier functional within the unique identification system of the requested Merchant system. Next, a properly formatted entry mechanism URL is returned, enabling a hand off to the target Merchant affiliate system and including the correlated target Webmaster unique identifier. The Virtual Affiliate system is notified of transactions that originated from a referring Webmaster. Referring Webmasters may be compensated for each completed transaction according to agreed-upon terms and conditions.

### SUMMARY OF THE INVENTION

A community-powered shared revenue program enables users to share product information, so that when the product is purchased, those who shared the product information leading to the sale will be rewarded with a percentage of the sale.

### BRIEF DESCRIPTION OF THE DRAWINGS

FIG. 1 illustrates a flowchart of a method of implementing a community-powered shared revenue program according to some embodiments.

FIG. 2 illustrates a diagram of a payment scheme of a community-powered shared revenue program according to some embodiments.

FIG. 3 illustrates a block diagram of an exemplary computing device configured to implement a community-powered shared revenue program according to some embodiments.

FIG. 4 illustrates a diagram of a network of devices implementing a community-powered shared revenue program according to some embodiments.

FIG. 5 illustrates a diagram of participants in a community-powered shared revenue program according to some embodiments.

FIG. 6 illustrates a flowchart of a method of implementing a community-powered shared revenue program according to some embodiments.

FIGS. 7-9 show exemplary screenshots of page flipping according to some embodiments.

FIG. 10 illustrates an exemplary screenshot of a publisher's blog according to some embodiments.

FIG. 11 illustrates an exemplary screenshot of a multi-frame web page according to some embodiments.

FIG. 12 illustrates an exemplary screenshot of a multi-frame web page with search results according to some embodiments.

FIG. 13 illustrates an exemplary screenshot of page flipping according to some embodiments.

FIG. 14 illustrates an exemplary screenshot of a profile for a page flipping app according to some embodiments.

FIG. 15 illustrates an exemplary screenshot of organizing a portfolio according to some embodiments.

FIG. 16 illustrates an exemplary screenshot of a design studio according to some embodiments.

FIG. 17 illustrates an exemplary screenshot of an image clipping tool according to some embodiments.

FIG. 18 illustrates an exemplary screenshot of a shoppable page according to some embodiments.

FIG. 19 illustrates an exemplary screenshot of a sponsored post disclosure page according to some embodiments.

FIG. 20 illustrates an exemplary screenshot of an interface displaying Blinks™ according to some embodiments.

FIG. 21 illustrates an exemplary screenshot of an interface displaying feeds according to some embodiments.

FIG. 22 illustrates an exemplary screenshot of an interface displaying favorites according to some embodiments.

FIG. 23 illustrates an exemplary screenshot of an interface displaying affiliate providers for selection according to some embodiments.

FIG. 24 illustrates an exemplary screenshot of an interface for selecting images to be published in an image carousel according to some embodiments.

FIG. 25 illustrates an exemplary screenshot of an interface of selected images to be published in an image carousel according to some embodiments.

FIG. 26 illustrates an exemplary screenshot of an interface of selected link images to be published in an image carousel according to some embodiments.

FIG. 27 illustrates an exemplary screenshot of an interface of selected images for an image carousel according to some embodiments.

FIG. 28 illustrates an exemplary screenshot of an interface of a selected image for an image carousel according to some embodiments.

FIG. 29 illustrates an exemplary screenshot of an interface of a flippable page according to some embodiments.

FIG. 30 illustrates an exemplary screenshot of an interface of a flippable page according to some embodiments.

FIG. 31 illustrates an exemplary screenshot of an interface of separate images of a slideshow according to some embodiments.

FIG. 32 illustrates an exemplary screenshot of an interface of separate images of a slideshow according to some embodiments.

FIG. 33 illustrates an exemplary screenshot of an interface of a publishing page according to some embodiments.

FIG. 34 illustrates an exemplary screenshot of an interface of a category page according to some embodiments.

FIG. 35 illustrates an exemplary screenshot of an interface of a selected flippable page and option to visit a linked site according to some embodiments.

FIG. 36 illustrates an exemplary screenshot of an interface for editing an image carousel according to some embodiments.

FIG. 37 illustrates an exemplary screenshot of an interface of a preview page according to some embodiments.

FIG. 38 illustrates an exemplary screenshot of an interface of a sharing page according to some embodiments.

FIG. 39 illustrates an exemplary screenshot of an interface of WordPress according to some embodiments.

FIG. 40 illustrates an exemplary screenshot of exemplary code to embed according to some embodiments.

### DETAILED DESCRIPTION OF THE INVENTION

A community-powered shared revenue program enables brands/companies to post products and users to share information related to these products to facilitate purchasing of the products. For example, Merchant X posts a product on Site Z, members (also referred to as publishers/revenue sharers) of Site Z share information about the product, and other members purchase the product on Site Z based on the shared information. Members who share the information leading to the purchase receive a percentage of the sale.

The typical participants involved in the community-powered shared revenue program include:
1. Merchant—a person/company selling an item. The merchant sets up a product with a website platform with basic information on their company (e.g., name and contact information), and they establish an account where funds are able to flow both in and out. In other words, they generate a virtual store. The merchants post product offerings. This is able to be a single product or a bundle of products. Each product offering may include one or more of: the price, the quantity of item/bundle of offering and expiration of offering. The merchant publishes their offer making it public or semi-public. “Public” is visible to all. “Semi-public” is visible to a specific group. Examples of a group include: only the revenue sharers, only revenue sharers with a specified status (e.g., celebrity or a threshold of established followers) or any other groupings.
2. Publisher/Revenue Sharer—a person sharing what Merchant is selling. Revenue sharers sign up. Each revenue sharer provides his/her name and sets up an account where funds will also flow in and out. A revenue sharer is able to be a publisher and vice versa. In some embodiments, revenue sharers also sell a product.
3. Network—provides software to track sales and provides the third party payment gateway (escrows and distributes funds). The software tracks the social sharing path to the point of the sale, and each revenue sharer involved in the sharing process shares the revenue share fee.
4. Customer—a person purchasing what Merchant is selling.
   After the different aspects of the service are set up (e.g., merchants, publishing offerings, and others), an offer is shared. A payment gateway including an instant purchase in social newsfeeds is used. A method of linking back to the publisher's website's shopping cart to complete the transaction is also able to be implemented. After a sale is made, each person in the social path of sharing that is also a member of the community-powered shared revenue program is compensated for the sale.

With the community-powered shared revenue program, there are many possible “viral” situations which result in significantly increased sales of a product. “Viral” is understood to be a rapid spread of information between social networking connections (e.g., friends spreading information of a product to each other which increases the visibility of the product). When a single merchant posts a product, revenue sharers and publishers are able to obtain information about that product and share the information with others. Then, as word spreads about the product, the sales of the product increase. When multiple merchants post products, the product information is able to be shared separately or jointly to increase the sales of the multiple products. Revenue sharers are able to be publishers and vice versa, such that not only does a revenue sharer earn money for sales of the product but also based on sharing the product information. Revenue sharers are able to re-share their own post from another viral share.

Any website is able to use the software to enable sharing of product information. Revenue sharers visit the site, share the information and make money. In some embodiments, the payout scheme for the revenue sharers is a pyramid scheme such that primary referrers receive a higher percentage payout than secondary referrers and so on.

Monetization includes recruitment of a product instead of recruitment of a person. In traditional multi-level marketing, people are recruited and a product is provided. In the community-powered shared revenue program, the community provides the product which is shared. The community provides the product by curating the product from product owners or other sites that list products for sale or posting products that other members curate.

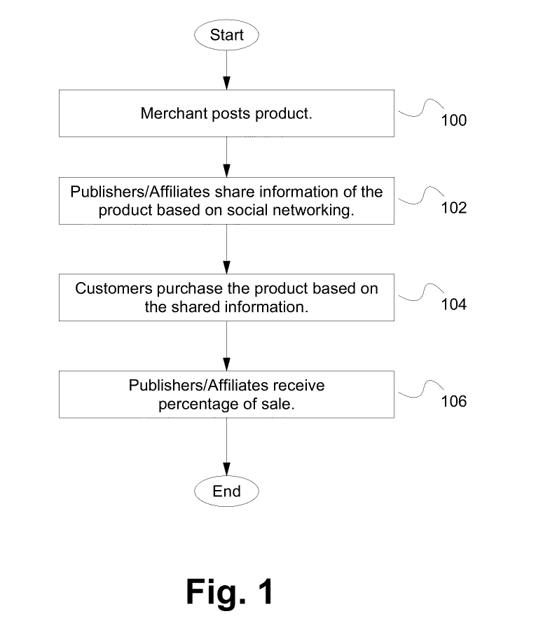

FIG. 1 illustrates a flowchart of a method of implementing a community-powered shared revenue program according to some embodiments. In the step 100, a merchant posts a product. For example, the product is posted on a centralized web site with a variety of products for sale. In another example, the merchant sells exercise equipment on her web site. In the step 102, publishers or revenue sharers share information of the product. Specifically, publishers or revenue sharers select (or pull) which product information they want to share, as opposed to the information being pushed on them. In some embodiments, the shared information is via email, social networking sites such as Facebook® or Twitter®, by clipping an image of the product and providing it to a contact (e.g., via messaging) or any other method. In some embodiments, when the information is shared, a sharing code is included so that the user sharing the information is able to receive credit for sharing the information when a product is purchased. The sharing code is able to be any type of code. In some embodiments, the sharing code identifies the product, the user sharing the code, and/or any prior sharers of the information. In the step 104, customers purchase the product based on the shared information. In some embodiments, the customers purchase the product at a centralized web site, and in some embodiments, the customers purchase the product at the individual merchant's web site. In the step 106, the publishers or revenue sharers who shared information that led to the purchase of the product receive a percentage of the sale. For example, a primary sharer (meaning the first person to share the information) receives 5% of the sale price, a secondary sharer receives 4% of the sale price, and so on to fractional percentages. In some embodiments, fewer or additional steps are implemented. In some embodiments, the order of the steps is modified.

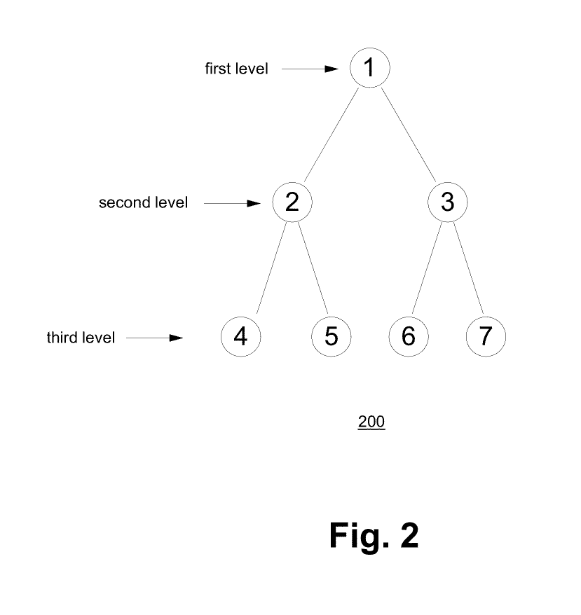

FIG. 2 illustrates an exemplary payment scheme for sharing according to some embodiments. Scheme 200 shows a pyramid scheme wherein each level of the pyramid receives a percentage. For example, the first level (also referred to as a primary sharer) receives n/2 of the sale price. The second level receives n/3 of the sale price, and the third level receives n/6 of the sale price. Additional levels are able to receive percentages as well. Although the percentage described herein is based on the sale price, the percentage could be based on a profit amount or any other amount. Additionally, the amount received does not need to be a percentage. For example, the amount received is able to be a set number such as $1 for each referral. Furthermore, other payment schemes are able to be implemented. For example, each sharer receives the same percentage regardless of level.

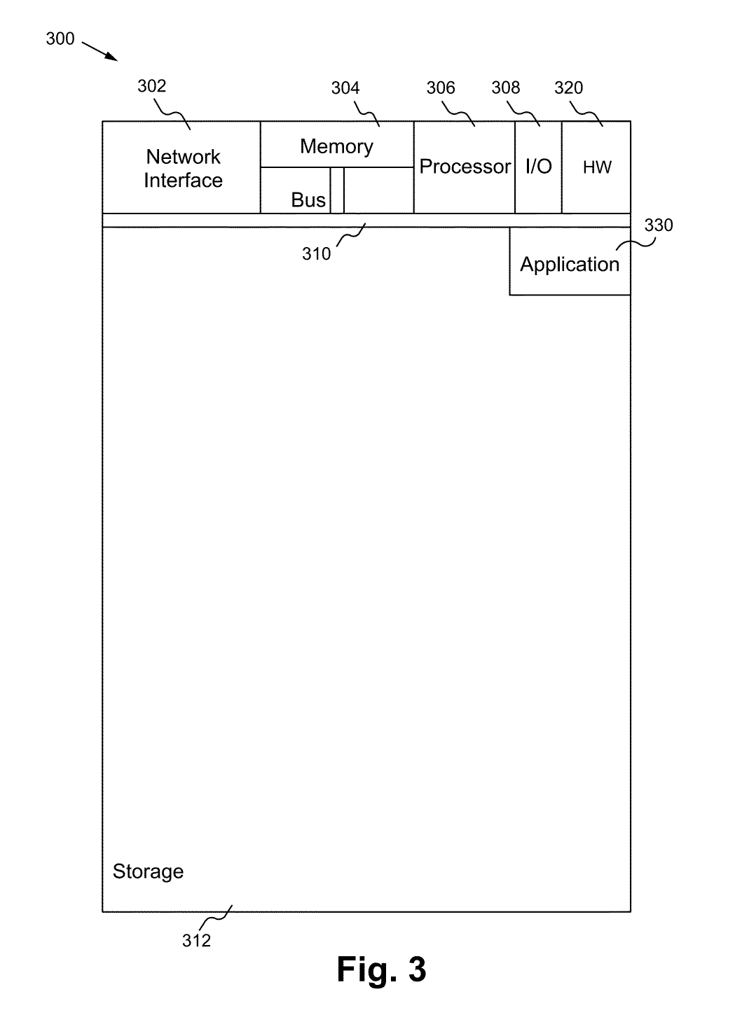

FIG. 3 illustrates a block diagram of an exemplary computing device 300 configured to implement the community-powered shared revenue program according to some embodiments. The computing device 300 is able to be one or more of servers, one or more of devices and/or other computing devices that are able to acquire, store, compute, communicate and/or display information such as text, images and videos. In general, a hardware structure suitable for implementing the computing device 300 includes a network interface 302, a memory 304, a processor 306, I/O device(s) 308, a bus 310 and a storage device 312. Alternatively, one or more of the illustrated components are able to be removed or substituted for other components well known in the art. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. Community-powered shared revenue program application(s) or module(s) 330 used to operate the application or downloadable application are likely to be stored in the storage device 312 and memory 304 and processed as applications are typically processed. More or fewer components shown in FIG. 3 are able to be included in the computing device 300. In some embodiments, community-powered shared revenue program hardware 320 is included. Although the computing device 300 in FIG. 3 includes applications 330 and hardware 320 for the community-powered shared revenue program, the community-powered shared revenue program method is able to be implemented on a computing device in hardware, firmware, software or any combination thereof.

In some embodiments, the community-powered shared revenue program application(s) 330 include several applications and/or modules. The modules implement the method described herein. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®, a video player, a DVD writer/player, a Blu-ray® writer/player, a television, a home entertainment system or any other suitable computing device.

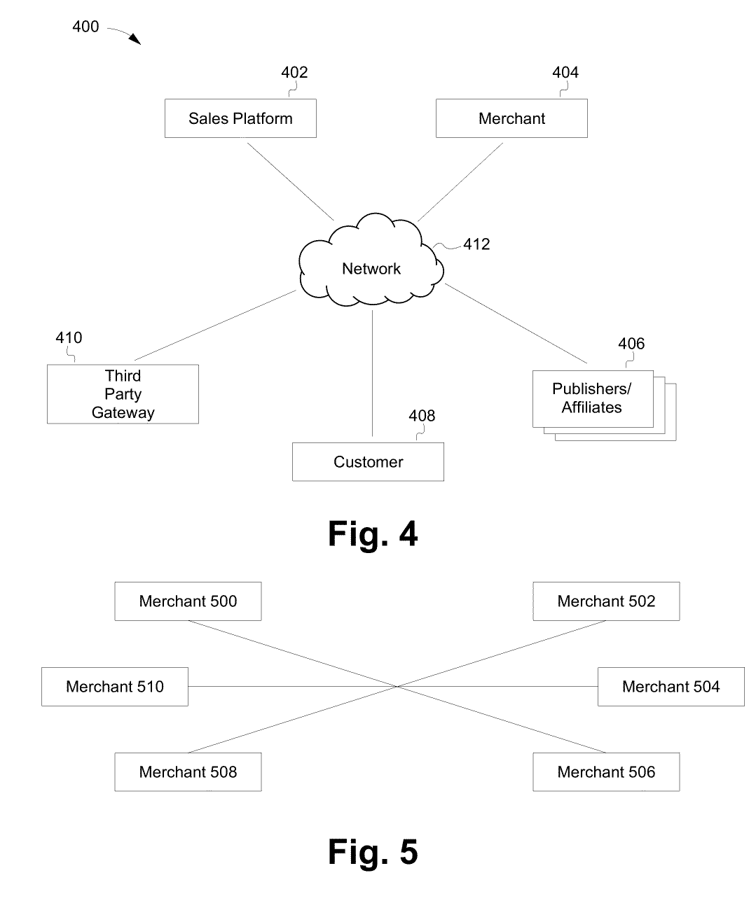

FIG. 4 illustrates a diagram of a network of devices for implementing a community-powered shared revenue program according to some embodiments. The network of devices 400 includes a sales platform device 402, a merchant device 404, publisher/revenue sharer devices 406, a customer device 408 and a third party gateway device 410 which are able to communicate over a network 412 such as the Internet. The sales platform device 402 is where a merchant is able to post his/her products for sale. For example, the sales platform device 402 hosts a website which provides many different products for sale. The merchant device 404 is any device that is able to communicate with the sales platform 402 for the merchant to post products. For example, the device is capable of uploading images and providing information such as sales price. The publisher/revenue sharer devices 406 enable users to review information on the sales platform 402 as well as share product information with others. Customer devices 408 enable customers to purchase products on the sales platform 402 using any method of purchasing over a network. The third party gateway device 410 performs escrows, determines sharing paths and any other functions useful to facilitate the community-powered shared revenue program. In some embodiments, fewer or additional devices are included in the network of devices 400.

As described above, the product information is able to be shared in any way. In some embodiments, users share product information by sending or pushing content (e.g., clipped images) to other locations such as other devices, accounts and/or destinations (e.g. Twitter®, Facebook®), as well as to define access privileges of the content. A user is able to select content and then select a command on the user interface that shares the content to another website (e.g. Facebook®) or device (e.g. an email to a computer). Alternatively or in addition, a user is able to use the module to associate one or more accounts with the content thereby defining access privileges to the content that is stored with the content. The content is able to be displayed as a “flip page” such that pages (or content) on the screen flip, similar to the appearance of pages of a book turning. In particular, the flip page transition gives the user the feel that they are flipping through a photo album, while a looped aspect of the picture sequence enables the sequence to be easily navigated to find and move between desired images.

In some embodiments, the product is shared using a website having a graphical user interface with an ad feature that enables users to create, submit and/or publish advertisement content on the website, wherein the content is associated with an area and/or a category and displayed to one or more users on the website with a display feature based on the area and/or category. Specifically, users are able to access the website with a web browser and submit location and/or category information such that the website is able to sort stored content based on the submitted location and/or category and display the sorted content to the user. Additionally, the graphical user interface of the website is able to have a register feature that when accessed by a user enables the user to create a user profile with the website that optionally includes location information and/or preferred category information. As a result, when logged into the account on the website, the website is able to display content associated with the location information and/or category information associated with the account.

A content creation feature enables a user to create video, audio, text, graphic or other types of content by providing software for recording, storing and editing the content. For example, the content creation feature of the graphical user interface is able to include software tools that enable separately inputted content to be combined, and the combined or separate content to be subject to video, audio, textual and graphical tools as are well known in the art. The submitted and/or created content is able to be any type of content such as video, audio, text (e.g. product information, price, call to action), graphics (e.g. trademarks) or combinations thereof. For example, the content is able to comprise coupons for a service having graphics and text indicating the terms of the coupon. Alternatively, the content is able to comprise an advertisement including a video describing a product for sale. In some embodiments, the creation feature comprises instructions that are provided to the user for using the creation feature (e.g. video, audio and/or textual instructions). Thus, in operation, for example, a registered user is able to upload an image or other type of content associated with a product that they wish to sell, enter information about the product to be associated within the product and/or displayed along with the content (e.g. price, description, listing start date and/or listing end date), and submit the completed ad to the website via a submission feature. Thus, the interface provides users with the advantage of being able to create their own ads and display the ads on the website.

In some embodiments, merchants post products, publishers/revenue sharers share flip page content, and the sale occurs on a specific sales platform. In some embodiments, the icon for the specific sales platform is displayed with a product to indicate they are a merchant member of the specific sales platform. A member is able to “clip” a single item or to add it to a flip page book from another site.

A clipper feature enables automatically generating a store that the merchant claims. Miniature products are able to be aggregated by combining product information and enabling the products to be purchased as a group. To utilize the community-powered shared revenue program, users share product information with each other, and the sharers are rewarded when a merchant's product is purchased. Code accompanies the product information so that the sharers receive the appropriate compensation.

FIG. 5 illustrates a diagram of participants in a community-powered shared revenue program according to some embodiments. Member 500 is a service providing software (e.g., mobile app) and a platform for clipping and sharing content. For example, the service enables users to perform the steps described above. More specifically, the service enables users to copy content (e.g., an image and/or text) from product information, edit the content (e.g., by providing additional commentary about the service or item in the information, and share the edited content (e.g., by social networking) Member 502 is a brand such as a company that agrees to a revenue sharing or splitting scheme. Member 504 is a social sponsor and is also a sponsor who finds the brand and shares a clipped and edited content. Member 504 also agrees to receive revenue from sales of Member 500 and Member 502. Member 504 is able to share the clipped and edited content on their blog, through email, Twitter, Facebook or any other social network sites or through Member 500′s site. Member 506 is a social curator who does not sponsor the brand/product being sold; however, shares the brand/product which results in a sale. In some embodiments, Member 506 receives the brand/product from Member 504 after Member 504 shares it with Member 506. Member 508 is a social networking site (or other site) where the point of sale happens. In some embodiments, a payment gateway is used for escrow and distributing funds. In some embodiments, there are fewer or additional members/parties involved. The payment upon a purchase depends on the member.

The following are exemplary payment models (percentages are of revenue or sale price):
1) Member 500 receives 5%, Member 504 receives 15% and Member 508 receives 10%.
2) Member 500 receives 20% and Member 504 receives 10%.
3) Member 500 receives 5%, Member 502 receives 15% and Member 504 receives 10%.
4) Member 500 receives 5%, Member 502 receives 20% and Member 504 receives 5%.

5) Member 500 receives 5%, Member 502 receives 5%, Member 504 receives 5% and Member 508 receives 15%.
6) Member 500 receives 15%, Member 502 receives 5% and Member 504 receives 5%.

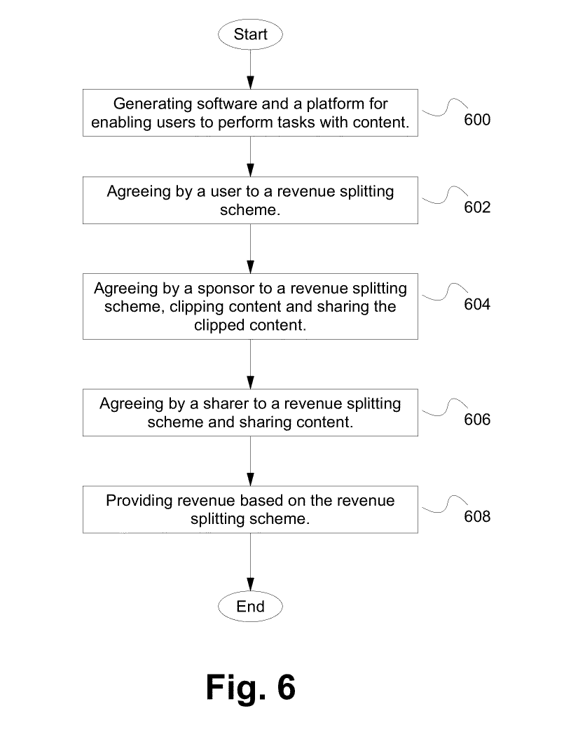

FIG. 6 illustrates a flowchart of a method of implementing a community-powered shared revenue program according to some embodiments. In the step 600, software and a platform are generated for enabling users to view, clip, edit, post, share and perform other tasks with content. In the step 602, a user (e.g., member 502) agrees to a revenue split scheme. In the step 604, a sponsor (e.g., member 504) agrees to receive revenue from sales and shares clipped content. In the step 606, a user (e.g., member 506) edits and shares content to receive revenue when there is a sale. In the step 608, when a sale is made, users who shared content which led to the sale receive revenue from the sale. In some embodiments, a sponsor receives a higher percentage of the revenue than a sharer who is not a sponsor. In some embodiments, fewer or additional steps are implemented.

In some embodiments, the distribution of group commissions is based on individual social network value and/or content generation. For example, a person who generates additional content related to a product or product information receives preferential commissions over a person simply sharing unmodified content. In some embodiments, a user providing a platform for sharing content receives preferential commissions over the user generating additional content over the user simply sharing content. In some embodiments, a user is able to be in the position of both content generator and sharer and be an owner of an item. In some embodiments, the percentage is based on the number of members of a user's social network. For example, if User A shares a clipped advertisement with his social network of 5 people, and User B shares the clipped advertisement with his social network of 500 people, then User B receives a higher percentage of the sale price.

In operation, the community-powered shared revenue program is different than Amazon.com in several ways. Amazon.com selects the products to sell; however, in the community-powered shared revenue program, each individual merchant chooses the offering. The revenue sharers in the community-powered shared revenue program do not have to be owners of a website; rather, they are social sharers. With the community-powered shared revenue program, payments are made to a specific sales platform through an application or online (e.g., check out occurs on the specific sales platform). Additionally, although Essociate provides affiliate pooling, there does not appear to be linking of sharing such that subsequent sharers are able to receive a percentage of a sale but a percentage that is less than a prior sharer. Essociate also does not describe sharing using a flip page book approach.

An example of the community-powered shared revenue program is provided herein. Merchant posts a new exercise device for sale on Website Z, and in the posting is an image of the device as well as a text description of the device including benefits, pricing and other information. Revenue sharer clips the image, edits the image so that it is in a flippable configuration and adds commentary of her own. In some embodiments, Revenue sharer clips the image using a tool provided by Website Z which implements a tool similar to a cut-and-paste tool that allows a user to select/highlight/outline an image or video and capture the content for editing. Revenue sharer then shares the clipped image with social networking contacts who also share the clipped image. Buyer sees the clipped image and purchases the exercise device using a method that includes information about the revenue sharer who shared the clipped image. Revenue sharer is given 1% of the sales price for sharing the information which led to the purchase of the product.

Furthering the example above, Merchant and Revenue sharer register as a merchant and revenue sharer with Website Z, respectively. When Revenue sharer generates the shareable clipped image, code (e.g., a Universal Resource Locator) is generated to accompany the image. The code identifies Revenue sharer. If the image is shared again by Revenue sharer 2 after receiving the image from Revenue sharer, the code will identify Revenue sharer and Revenue sharer 2, including indicating that Revenue sharer is a primary sharer and Revenue sharer 2 is a secondary sharer. In some embodiments, Revenue sharer 2 is able to edit/modify the image that Revenue sharer generated. In addition to or instead of paying Revenue sharer monetary rewards, other rewards are available such as credits to a specific web site (e.g., Website Z) or any other bonuses/benefits.

In some embodiments, a content feed (e.g., news feed, shopping grid feed, social network news feed, text feed, blog feed, or any other feed) is presented in reverse chronological order (or chronological order) such as up and down vertically or left to right horizontally. For example, newer groups of content items are presented at the top with older groups of content items presented lower on the screen.

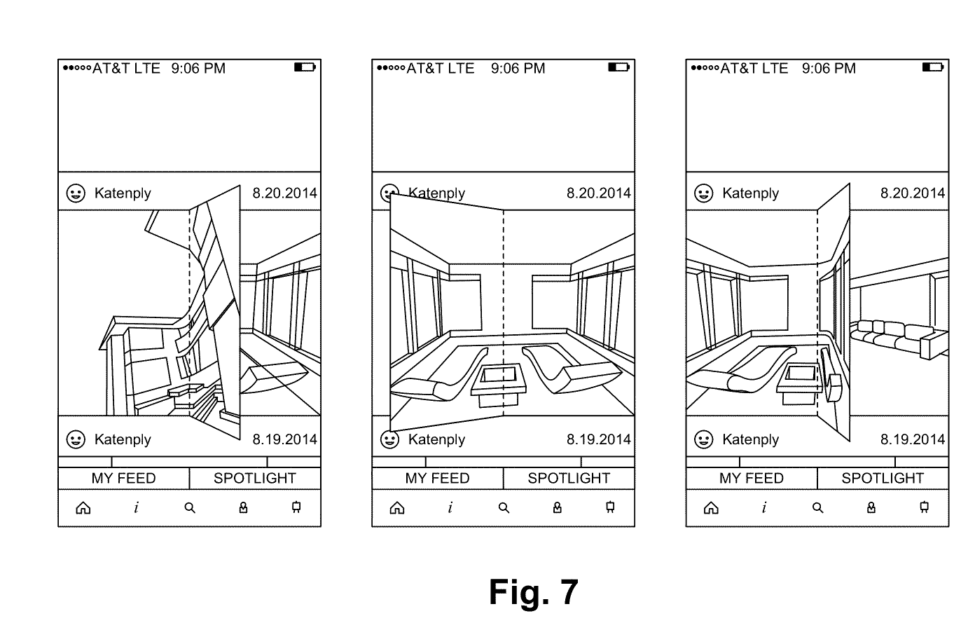

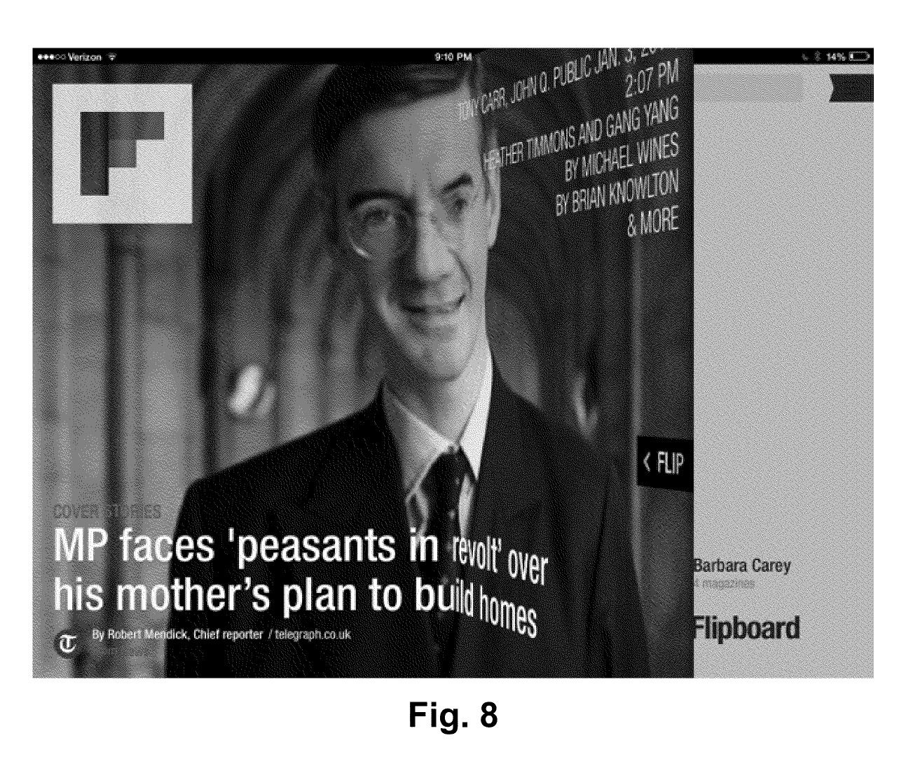

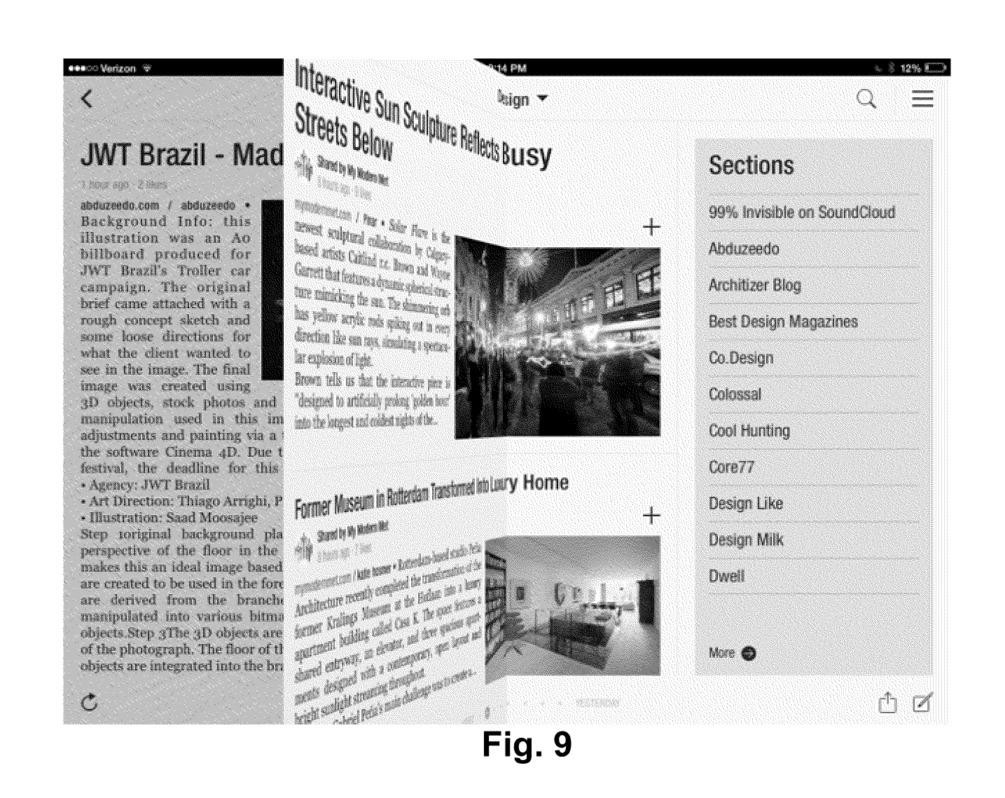

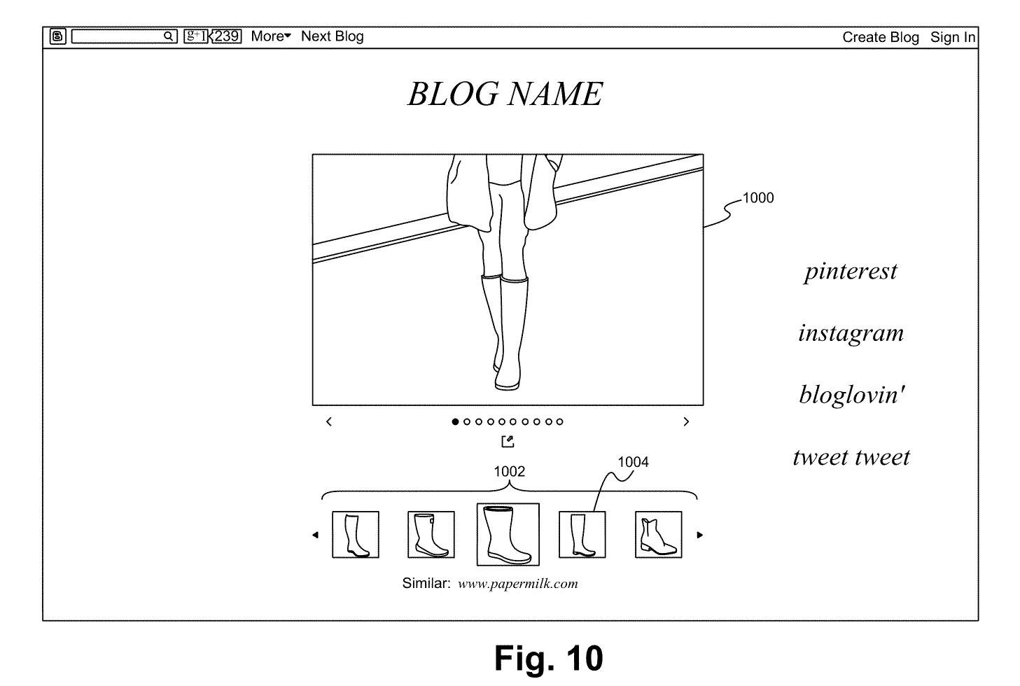

In some embodiments, each content item in the content feed is able to be flipped like flipping a standard paper page. FIGS. 7-9 show exemplary screenshots of page flipping according to some embodiments. The appearance of the page remains the content item until the page is fully flipped. The opposite side of the page being flipped is the next content item. In some embodiments, the page flips at approximately the middle of the content item with a first portion of the content item remaining stationary and the second portion flipping. When the second portion is flipping, the next content item within the group is partially displayed, and more of the next content item is displayed as the page is flipped until it is fully flipped, and the next content item is fully displayed. For example, a user swipes her finger on the displayed content of a content group on a smart phone display to flip pages from right to left to display additional content within the group. As the user swipes her finger, the content item is divided in half, and the right half turns as a paper page would by following the user's finger. The page is fully viewable while it is being flipped. For example, the left half of an image and the right half of an image are viewable while a page is being flipped. Additionally, on the opposite side of the flipping page is the left portion of the next content item. The user is able to move the flipping page back and forth, and the content item is displayed on the left side including the front of the flipping page, and the next content item is displayed on the right side including the back of the flipping page. This allows multiple items in a group to be viewable while also showing additional groups in the news feed. The content items are able to be videos, text (SMS) messages, microblogging posts (e.g., Tweets), images such as jpegs, gifs, and/or other content. In some embodiments, an “auto play” implementation is utilized to flip the pages. For example, the user simply taps the front/top of a group of content items, and the content items are flipped through at a settable rate. In some embodiments, there is a visual indicator to inform the viewer that there are multiple images in a group (e.g., a corner effect or tracking dots). With the pages being able to be flipped, viewers are able to view multiple photos right in the feed and without a transition to a secondary page.

In some embodiments, a user profile is able to be dragged up and down from a hidden view to a display view. After the profile is in the display view, the user is able to modify her settings.

FIG. 10 illustrates an exemplary screenshot of a publisher's blog according to some embodiments. The blog includes content 1000. The content 1000 is able to be any type of content such as images, text, videos, games, applications, and/or other content. Positioned in or near the content 1000 are images 1002 (or other content) of one or more items within the content 1000. Each of the images 1002 includes a hypertext link to a merchant's site (or the merchant's site embedded in another web page) to purchase the item. In some embodiments, alternative items 1004 are included within the images 1002. The alternative items 1004 are able to be different colors, different brands, different styles, the same item but from a different merchant and/or any other alternatives. In some embodiments, the alternative items 1004 are different but similar in one or more aspects. For example, the only difference between the item and the alternative item is color, or the color is the same but the brand is different (e.g., a knock-off). The alternative items 1004 are able to be linked to the item in any manner (e.g., a database stores the original item and alternative items). In another example, alternative items are automatically located based on relational databases of merchant sites (e.g., similar to how Amazon.com® recommends items based on the current item). In another example, alternative items are automatically searched for based on image matching or text description matching, and a database is automatically populated based on the search results (e.g., the first five results returned are placed in the database as alternatives to the item). Although a blog is shown, any publisher web page or app is able to be utilized. When a user selects an item (e.g., by clicking one of the images 1002), the browser presents a multi-frame web page.

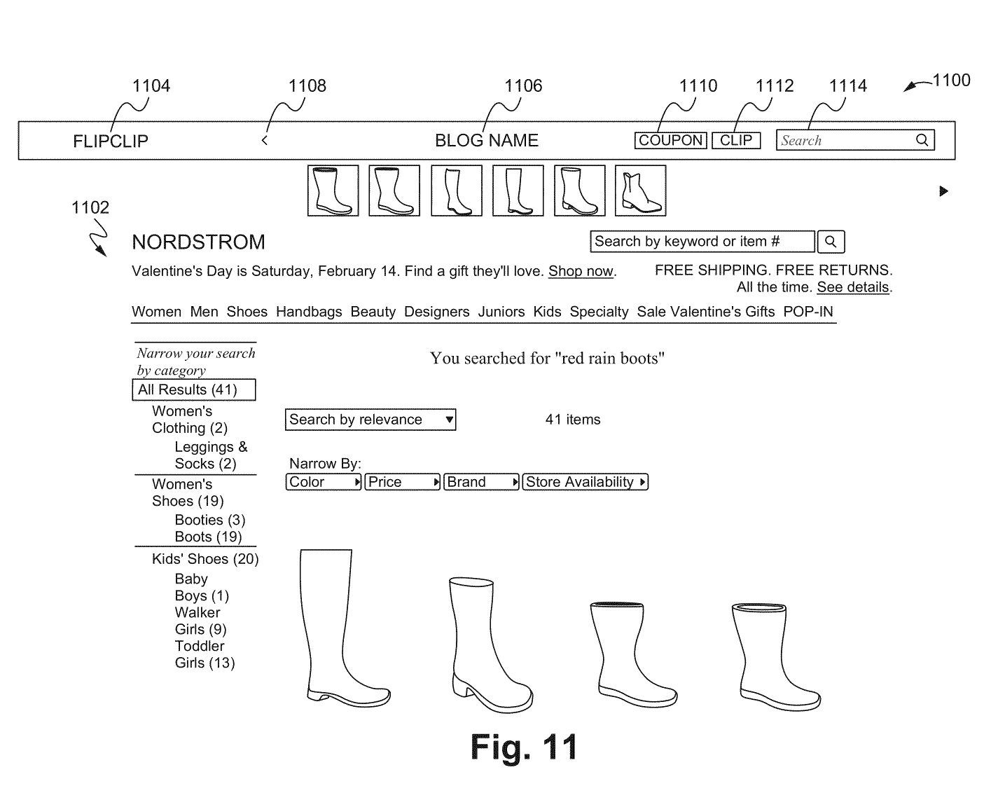

FIG. 11 illustrates an exemplary screenshot of a multi-frame web page according to some embodiments. The multi-frame web page includes a main frame or body 1100 and one or more inline frames (“Iframes”) 1102. In some embodiments, the top portion of the web page is a first Iframe, and the bottom portion of the web page is a second Iframe. The positioning of the frames is able to be in any configuration. In some embodiments, one or more of the Iframes are contained within another Iframe.

The body 1100 includes information related to the publisher as well as other information. For example, the body 1100 indicates the network (e.g., the entity hosting the blog and/or providing tools to the users, such as FlipClip) 1104 and the publisher (e.g., Blog Name) 1106. In some embodiments, the body 1100 includes content from the network 1104 or publisher 1106, or from the web site of the network 1104 or the publisher 1106. For example, in some embodiments, the body 1100 incorporates html content from the web site of the publisher 1106. In some embodiments, the text labels (e.g., “FlipClip” and “Blog Name”) include hyperlinks to their respective web pages. In some embodiments, the body 1100 includes a “back” button/link 1108 which will take the user back to the web page that brought them to the current web page (e.g., the web page of FIG. 10). In some embodiments, the body 1100 includes a coupon button 1110 which displays a coupon (or coupon code) to enable the user to purchase the item at a discount. In some embodiments, the coupon is able to be included in a database or other storage linked with the multi-frame web page, or the coupon is searched for. The coupon is able to be searched for automatically by performing a search with keywords such as the item name and/or the merchant name. In some embodiments, the search is limited to sites that provide online coupon codes. In some embodiments, the body 1100 includes a “clip” button 1112 which allows the user to select/highlight/outline content (e.g., image, video, text) or a portion of the content and capture the content for editing as described herein. In some embodiments, the execution of the clip button 1112 includes embedding/connecting a publisher link or other identifier within the clipped content, so that others will be able to determine where the clipped content is from, and in some embodiments, the identification information is used for revenue sharing. For example, when a user visits a page with the clipped content, the identification information is passed from web page to web page so that if the user purchases an item based on the clipped content, the sharer (e.g., the person who clipped the content and shared it) is provided a share of the revenue of the sale. In some embodiments, the clip button 1112 includes an option for sharing the clipped content. For example, the clipped content is able to be shared via text message, email or posted to a blog or social networking site. In some embodiments, the body 1100 includes a search bar 1114. The search bar 1114 is able to use any search engine (e.g., Google®) to search for the input.

Included in the body 1100 is code (e.g., javascript) that monitors the purchase for revenue sharing purposes and provides information to the appropriate parties (e.g., the network), so that the correct parties receive their proper share of the revenue when a sale is made.

The Iframe 1102 includes the web page of the merchant. A user is able to navigate the web page as she normally would such as selecting the desired item, providing payment information and purchasing the item. Other than seeing the additional body/frame 1100, the merchant's web page in the Iframe 1102 looks and feels the same as if the user went directly to the merchant's web page. As described herein, computer code is able to track the customer's purchase and utilizes this information for revenue sharing.

Although a multi-frame web page is described herein, any web page that enables the page to maintain the look and feel of the desired web page but within another network (or host) is able to be implemented. For example, although a customer clicks a link for an item sold at Nordstrom.com, the customer is not taken directly to Nordstrom.com, the customer is taken to a page that looks like Nordstrom.com but is within Flipclip.com, or the page is Nordstrom.com but another network/host (e.g., Flipclip.com) is also receiving information related to the purchase (e.g., for revenue sharing purposes).

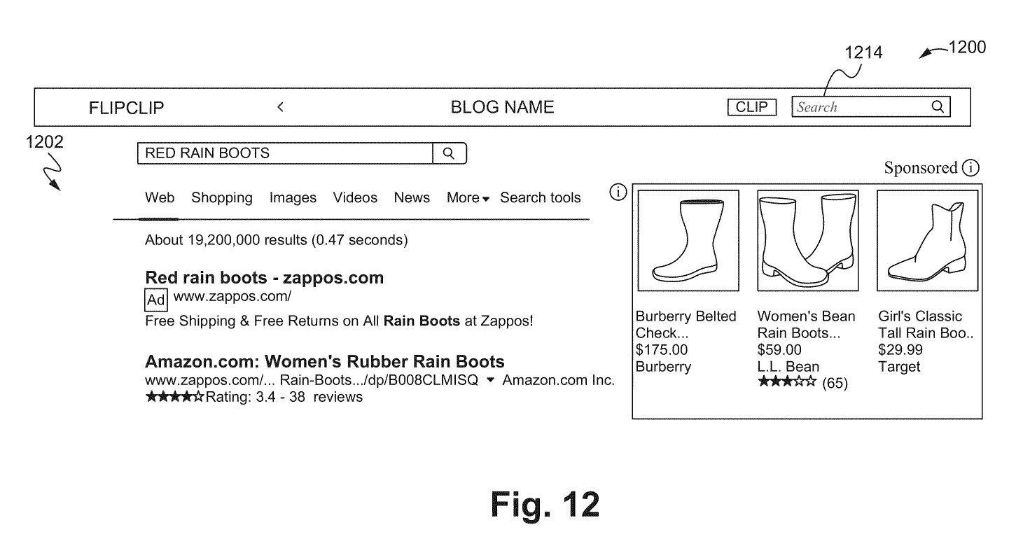

FIG. 12 illustrates an exemplary screenshot of a multi-frame web page with search results according to some embodiments. Similar to FIG. 11, the multi-frame web page includes a main frame or body 1200 and one or more Iframes 1202.

When a user inputs a text string (e.g., “red rain boots”) in the search bar 1214, the results are displayed in the Iframe 1202. The user is able to navigate using the links and other content in the Iframe 1202 the same way as if it were a standalone web page. However, computer code in the body 1200 is able to track the user's purchase for revenue sharing purposes. For example, the user (a potential customer) visits the “Blog Name” blog, and she likes the red rain boots shown in the picture. She searches for “red rain boots” in the search bar 1214. A search engine with search results is displayed in the Iframe 1202. The user then selects a link with the boots offered by a merchant (e.g. Zappos®). The user checks out and pays for the boots. Although the process was essentially the same for the user, since the user was referred to the merchant by the blog, the merchant should receive a portion of the revenue. Using the computer code which tracked the purchase, the publisher (e.g., “Blog Name” blog) is given a share of the revenue.

In some embodiments, the search utilizes the text in the search bar as well as the image on the blog or other web page. For example, Google® includes a feature to search by comparing images, so in addition to performing a search by comparing images, the text information in the search bar is also used for the search to produce a better search result.

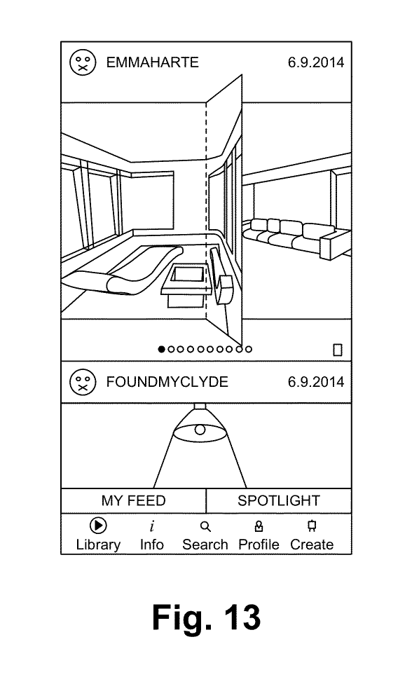

FIG. 13 illustrates an exemplary screenshot of page flipping according to some embodiments. As described herein a user is able to swipe through photos which flip as they are swiped and show part of an image on each side of the flipping page.

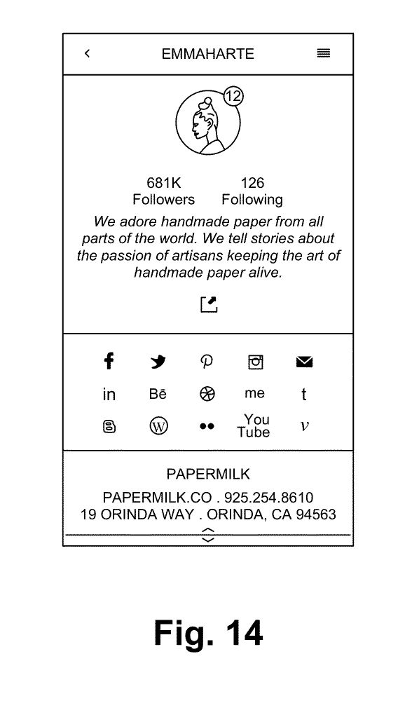

FIG. 14 illustrates an exemplary screenshot of a profile for a page flipping app according to some embodiments. A user is able to customize her profile and centralize her online presence through the app.

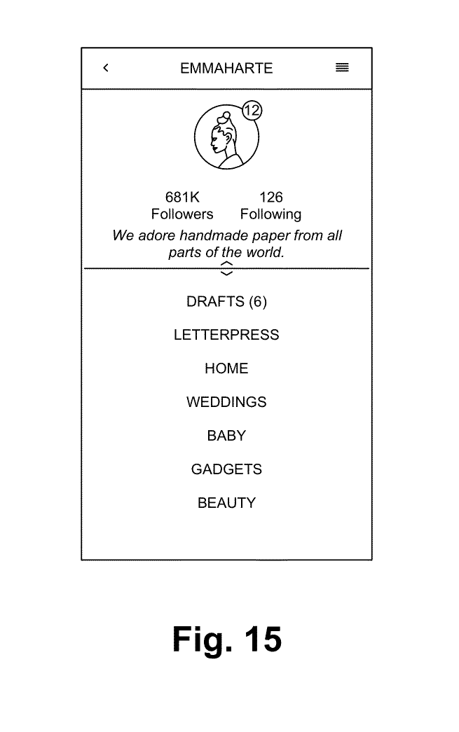

FIG. 15 illustrates an exemplary screenshot of organizing a portfolio according to some embodiments. An organizer is able to be used to generate a custom library of content where the user's generated content is able to be stored. For example, the user generates albums or folders such as weddings, baby, gadgets and beauty. Any other organizational techniques are able to be implemented.

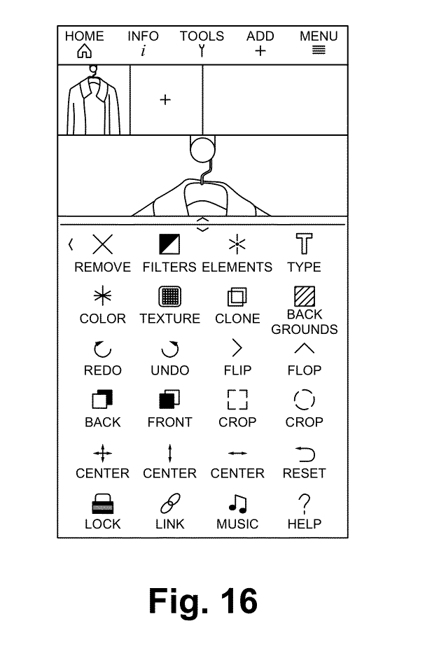

FIG. 16 illustrates an exemplary screenshot of a design studio according to some embodiments. The design studio is a full mobile design studio with many tools to design and edit photographs/images.

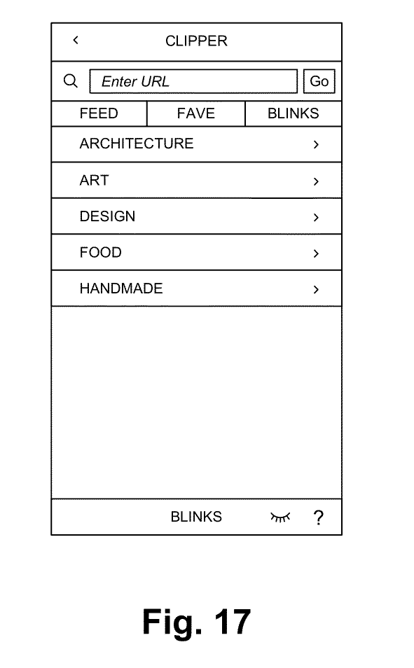

FIG. 17 illustrates an exemplary screenshot of an image clipping tool according to some embodiments. The image clipping tool allows a user to clip images from the Web and organize the clipped images with added content.

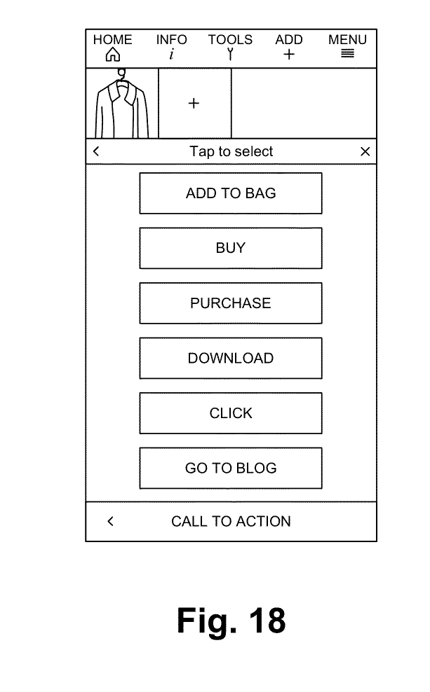

FIG. 18 illustrates an exemplary screenshot of a shoppable page according to some embodiments. The shoppable page enables a user to embed hot-links in her web page (e.g., blog) to sell products. For example, the hot-links are to merchants' sites and products for purchase.

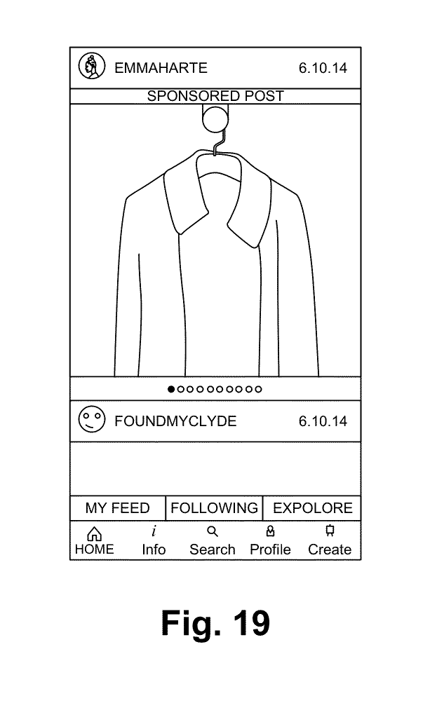

FIG. 19 illustrates an exemplary screenshot of a sponsored post disclosure page according to some embodiments. A one click, FTC-compliant sponsored post disclosure is able to be utilized.

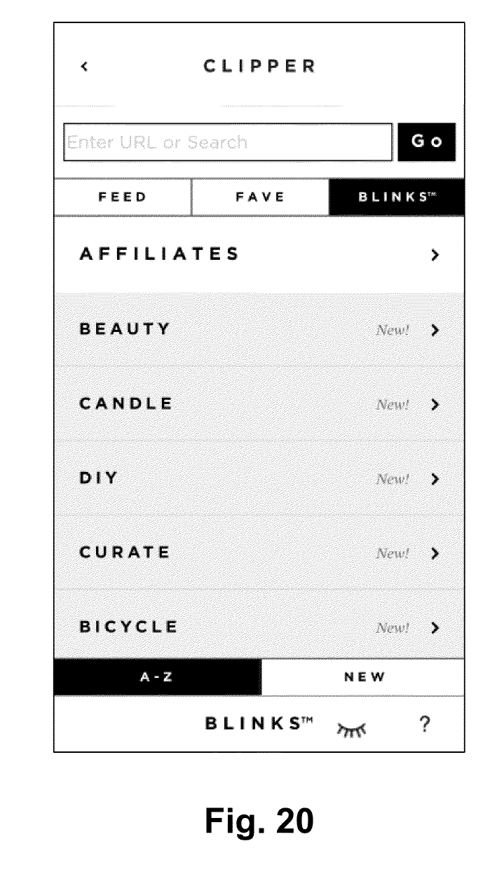

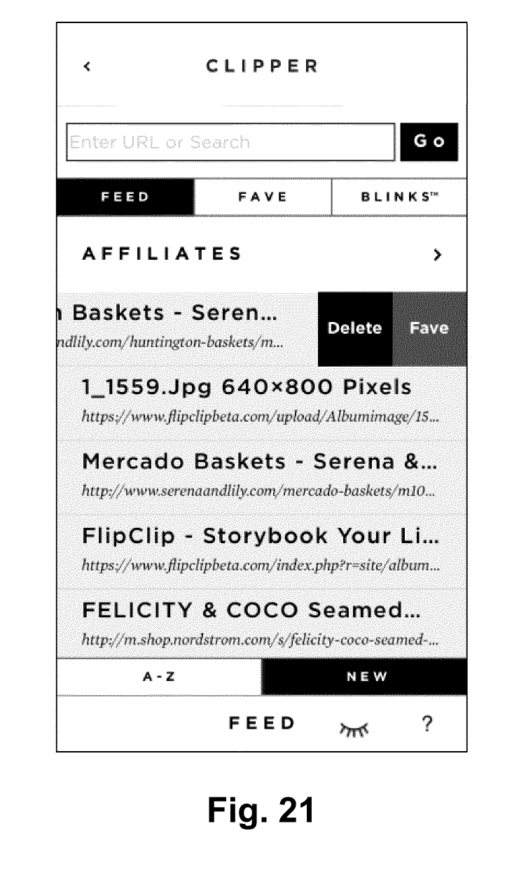

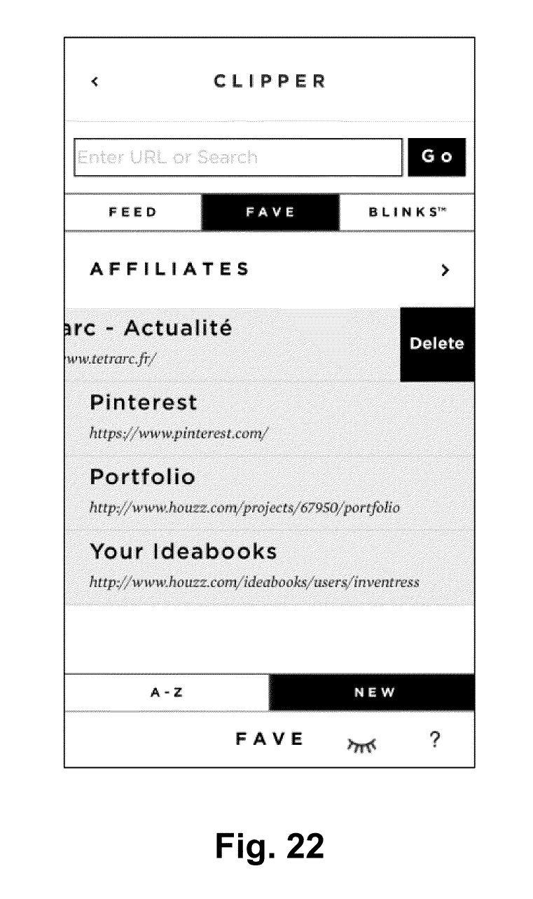

An exemplary website or app for capturing images and generating a flippable page includes several main heading such as Blinks™, Feed and Faye (favorites). FIG. 20 illustrates an exemplary screenshot of an interface displaying Blinks™ according to some embodiments. Blinks™ are links either paid by promotion or the linking “party” is offering a special offer to user or simply company promoted links. Blinks™ are able to be categorized and sorted. FIG. 21 illustrates an exemplary screenshot of an interface displaying feeds according to some embodiments. The feeds are able to be any news feeds (e.g., affiliates' news feeds). FIG. 22 illustrates an exemplary screenshot of an interface displaying favorites according to some embodiments. Favorites are selected sites, feeds or other content selected as a “favorite.” A web site or app is able to include a button or other input mechanism for a user to select content as a favorite.

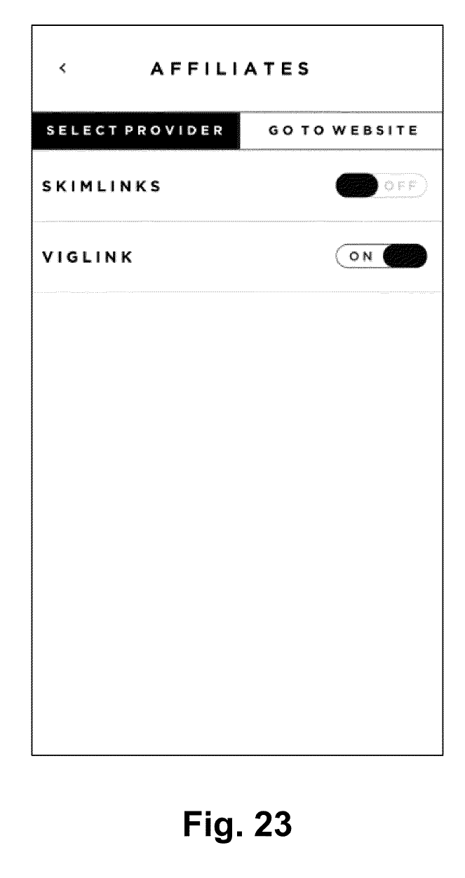

FIG. 23 illustrates an exemplary screenshot of an interface displaying affiliate providers for selection according to some embodiments. If a user turns on an affiliate provider (e.g., Skimlinks or Viglink), then for all of the links the user clips, the user's unique publisher ID is embedded into the link.

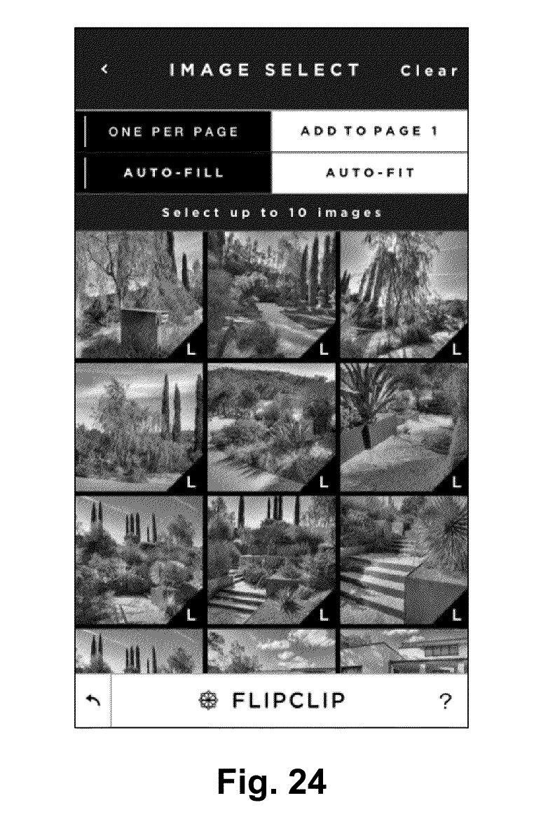

FIG. 24 illustrates an exemplary screenshot of an interface for selecting images to be published in an image carousel according to some embodiments. Using the image carousel generation tool (also referred to as an image clipping tool), a user is able to select images that will be part of an image carousel (e.g., page flipping book, slide show, looping carousel, image Iframe or other multiple image or content displaying item).

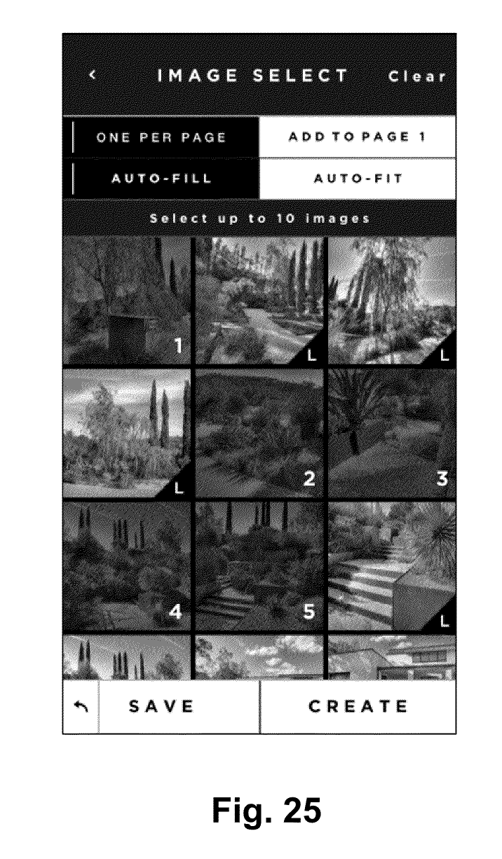

FIG. 25 illustrates an exemplary screenshot of an interface of selected images to be published in an image carousel according to some embodiments. The user is able to select the order of the images displayed in the image carousel. For example, the upper left image is selected to be displayed first, the middle image is selected to be displayed second, and so on. In some embodiments, the order of selecting each image determines the order the images will be displayed. For example, the user taps the upper left part of the screen selecting image 1, then taps the middle part of the screen selecting image 2, and so on. In another example, the user drags her finger to the middle of each image to select the image, and the order of dragging the finger determines the image display order. In some embodiments, the user is able to select/input a number for each image which corresponds to the display order.

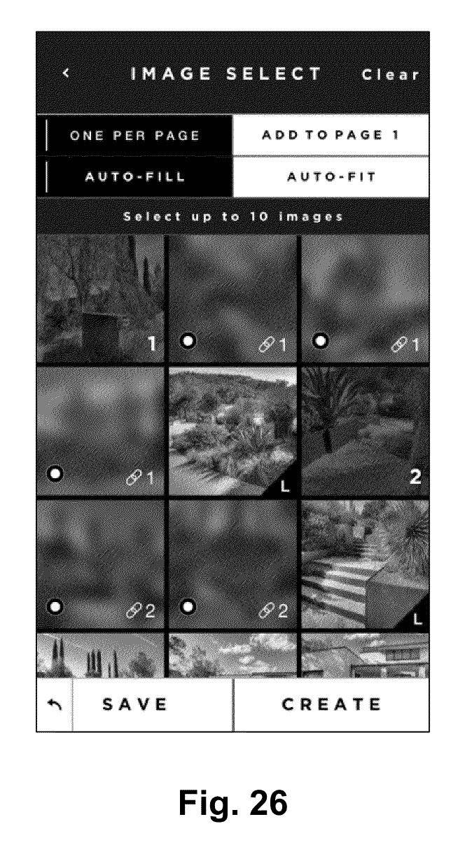

FIG. 26 illustrates an exemplary screenshot of an interface of selected link images to be published in an image carousel according to some embodiments. The images are able to include hyperlinks to other content (e.g., web sites). In some embodiments, the hyperlinks enable monetization using unique affiliated identifiers.

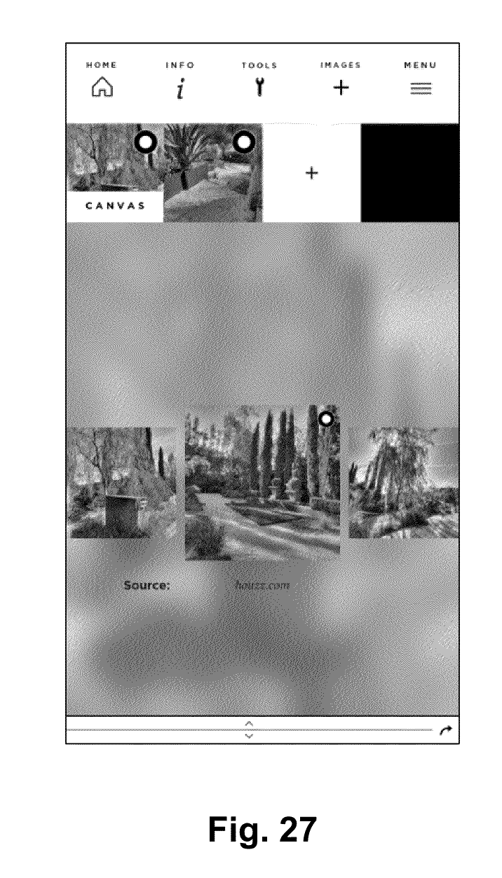

FIG. 27 illustrates an exemplary screenshot of an interface of selected images for an image carousel according to some embodiments. As described herein, a selected image is able to be edited and manipulated in many ways.

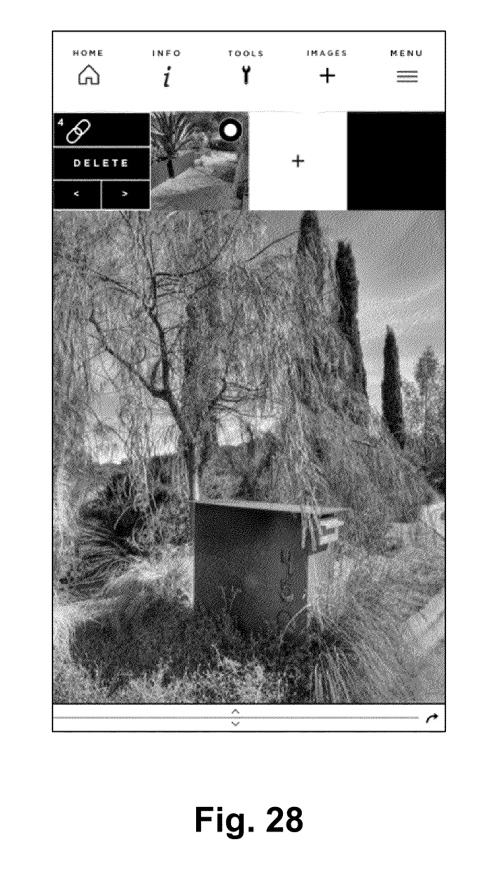

FIG. 28 illustrates an exemplary screenshot of an interface of a selected image for an image carousel according to some embodiments. Tools such as adding a hyperlink, deleting the image, and/or other tools are able to be used to edit an image of an image carousel.

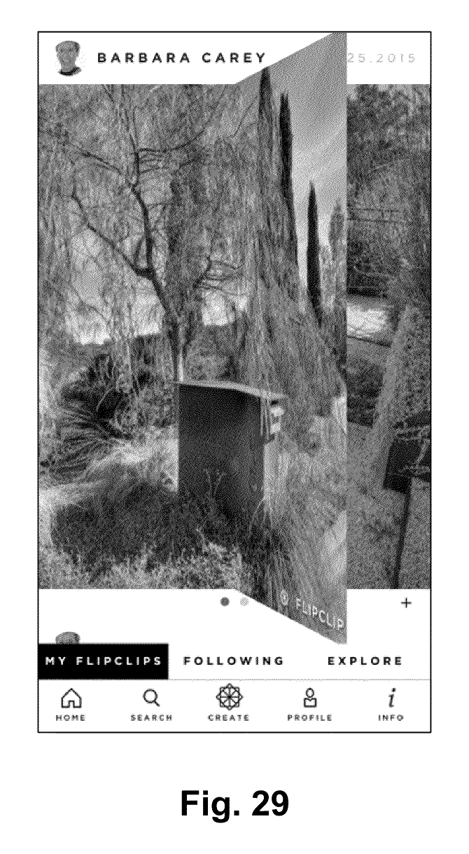

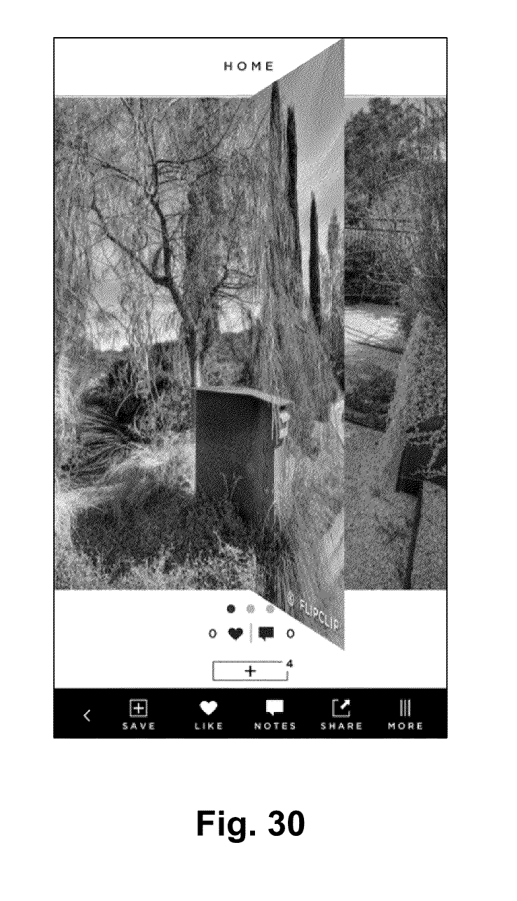

FIG. 29 illustrates an exemplary screenshot of an interface of a flippable page according to some embodiments. As described herein, a user is able to swipe across a screen to turn flippable pages of a flippable book. The flippable book is able to be accessed by any means such as by selecting a “my flipclips” tab. FIG. 30 illustrates an exemplary screenshot of an interface of a flippable page according to some embodiments. While viewing a flippable page, a user is able to perform many options on the flippable page/book such as save, like, take notes, share and others.

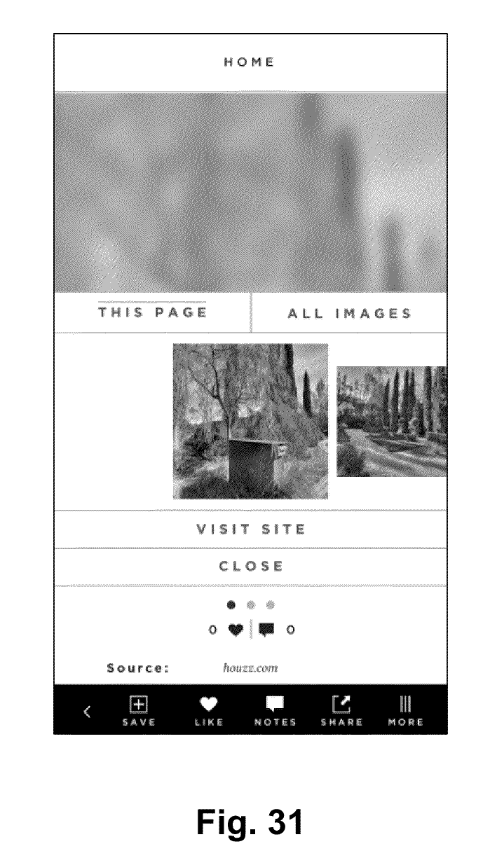

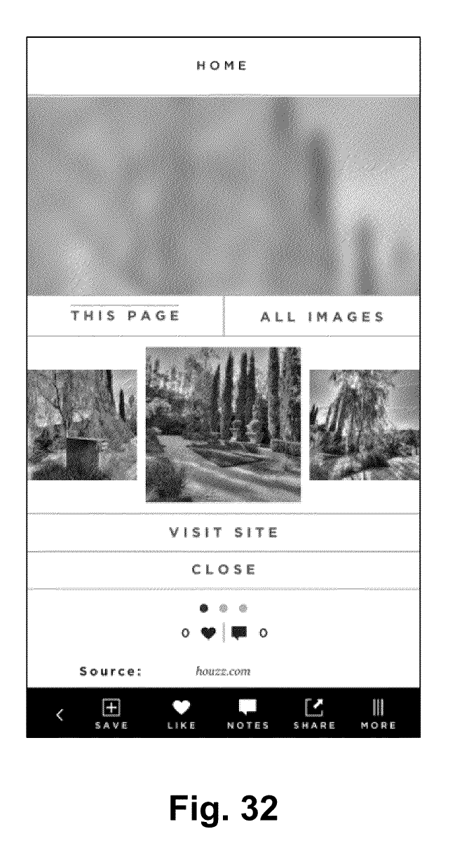

FIG. 31 illustrates an exemplary screenshot of an interface of separate images of a slideshow according to some embodiments. FIG. 32 illustrates an exemplary screenshot of an interface of separate images of a slideshow according to some embodiments. The user is able to scroll through the images of the slideshow. Additionally, while viewing a slideshow, a user is able to perform many options on the slideshow or image such as save, like, take notes, share and others.

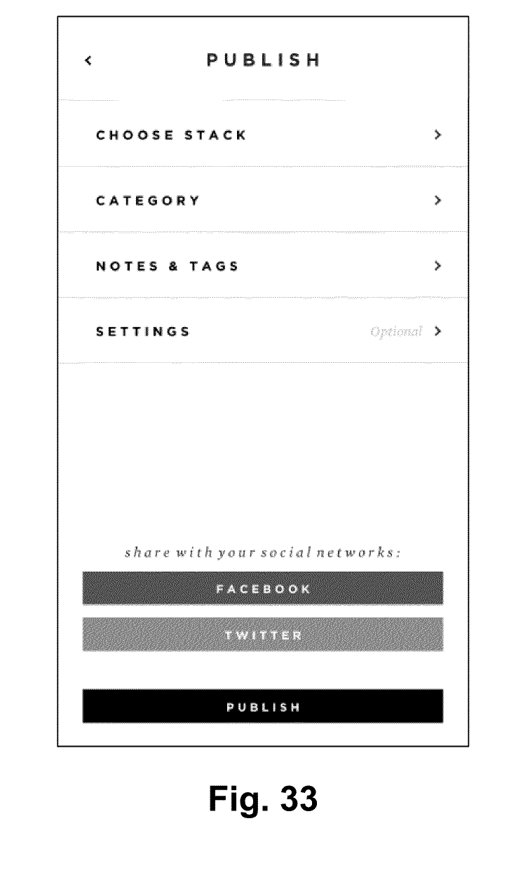

FIG. 33 illustrates an exemplary screenshot of an interface of a publishing page according to some embodiments. The publishing interface enables the user to select many options regarding publishing such as choosing a stack, a category for an image carousel, add notes and tags, and select other settings. The user is able to share the image carousel in any manner such as via social networks.

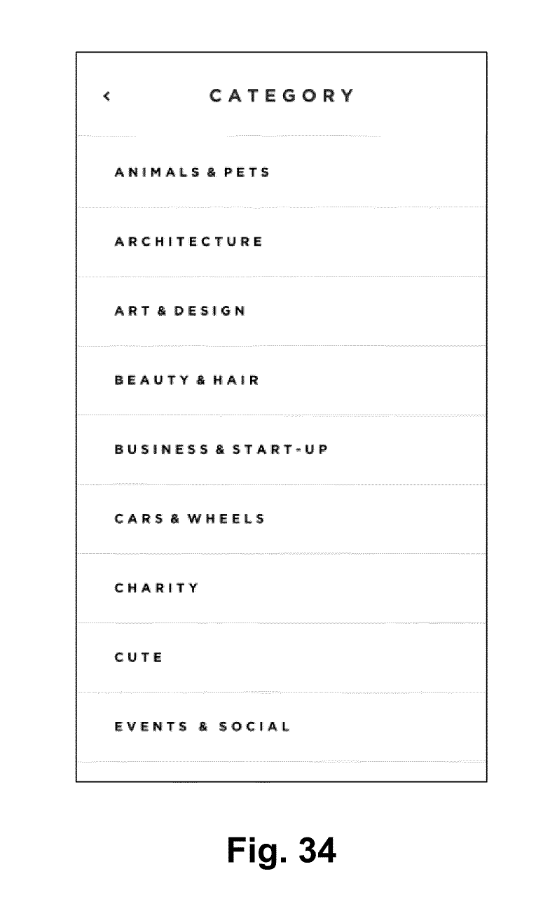

FIG. 34 illustrates an exemplary screenshot of an interface of a category page according to some embodiments. The category interface is useful for organizing image carousels, so that if a user generates a carousel of her dog, it is easily retrieved in the “animals & pets” category instead of searching through all of a user's image carousels.

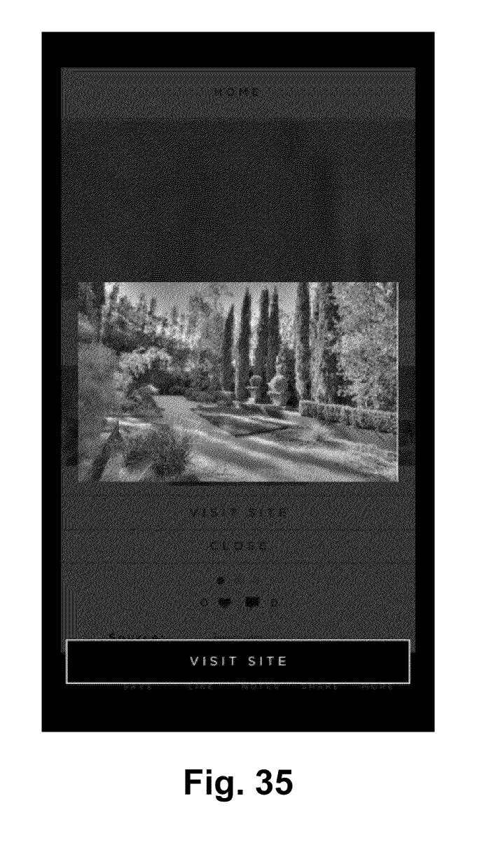

FIG. 35 illustrates an exemplary screenshot of an interface of a selected flippable page and option to visit a linked site according to some embodiments. When a flippable page includes a hyperlink to other content (e.g., web site), a user is able to click an input implementation to visit the linked web site.

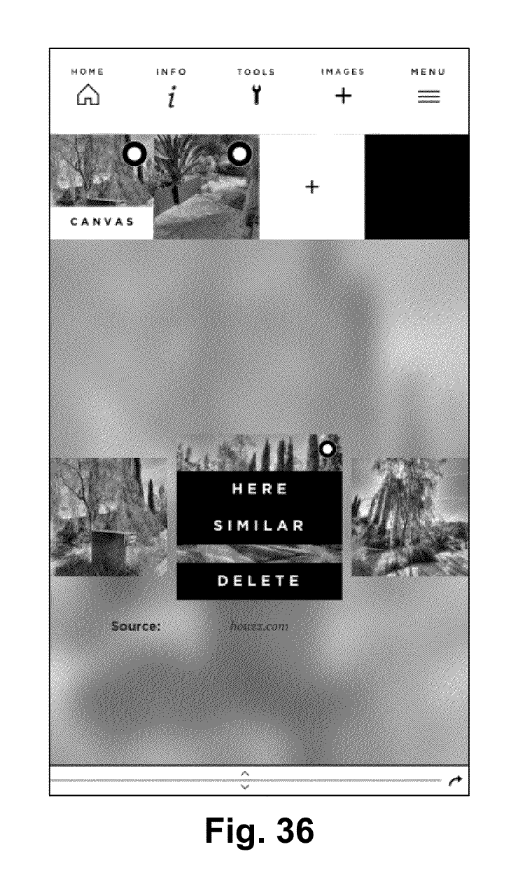

FIG. 36 illustrates an exemplary screenshot of an interface for editing an image carousel according to some embodiments. As described herein, many features are able to be utilized with image carousels such as tools to edit the image carousels and add images to the image carousels.

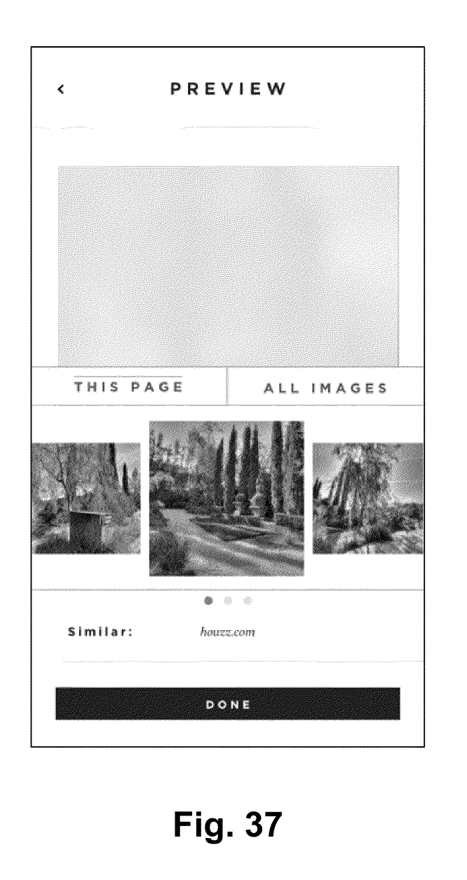

FIG. 37 illustrates an exemplary screenshot of an interface of a preview page according to some embodiments. The preview interface enables a user to preview an image carousel before publishing. When the user is finished previewing the image carousel, she is able to input that she is finished.

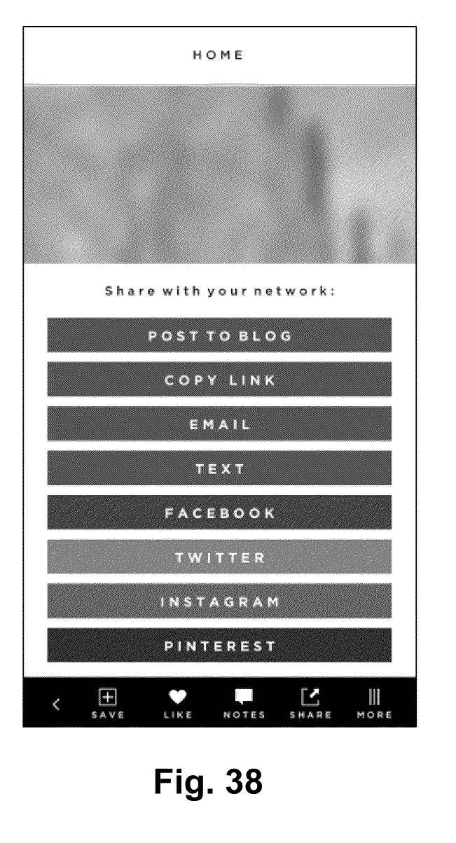

FIG. 38 illustrates an exemplary screenshot of an interface of a sharing page according to some embodiments. As described herein, the image carousel is able to be shared in any manner such as email, text and social networking.

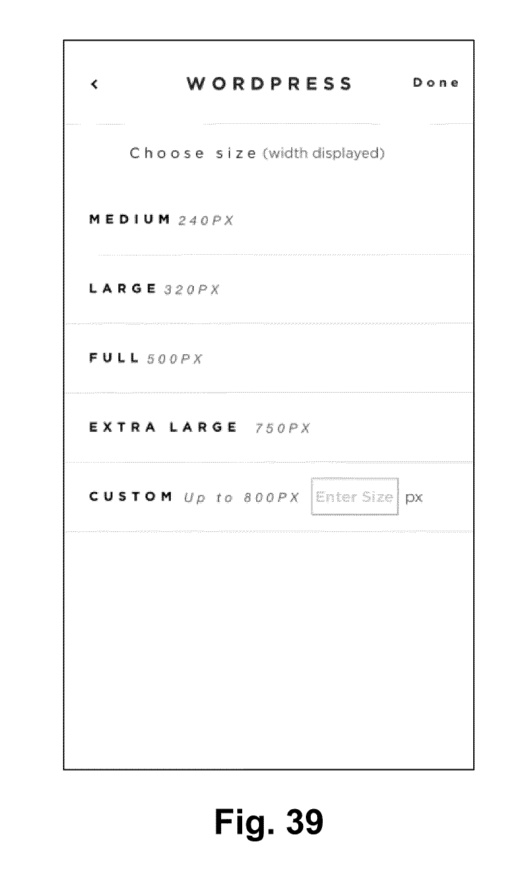

FIG. 39 illustrates an exemplary screenshot of an interface of WordPress according to some embodiments. A user is able to determine the size and quality of the image carousel when publishing to a blog.

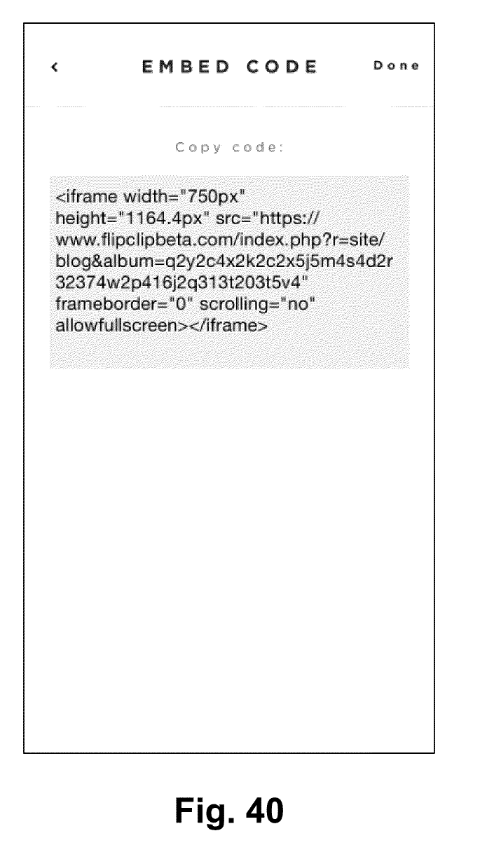

FIG. 40 illustrates an exemplary screenshot of exemplary code to embed according to some embodiments. In some embodiments, embedded code for an Iframe simply provides the content to be included within the Iframe, and in some embodiments, the embedded code includes identification information for monetization.

In some embodiments, a tool (e.g., a bookmarklet tool) is able to collect a plurality of link images with monetization (e.g., using unique affiliated IDs) or without monetization and publish the images in an image carousel such as a page flipping book, slide show, looping carousel or image Iframe. The tool is able to select/capture more than one image at a time. The images/pages are able to include links. The links are able to be used with or without monetization.

An exemplary implementation of the tool includes the following. If a user turns on an affiliate provider (skimlinks or viglinks), then for all of the links the user clips/captures, their unique publisher ID is embedded into the link. The tool clips images and keeps a history feed of the images. The tool is able to capture links and images. The user is able to swipe to organize links in a favorite file/folder. The user is also able to select Blinks™, which are links are either paid by promotion or the linking “party” is offering a special offer to users. The user is able to select a link (e.g., red square box), and under the mini browser (bookmarklet/clipper overlay), the site appears. Then, user selects “CLIP,” and the image carousel is generated or an additional window/page/interface is displayed for a user to edit and generate the image carousel.

Using a page flipping app or web site, a user is presented with many capabilities and functionality such as search capabilities, profile features and artistic/editing functionality (e.g., art studio). The app or web site is able to provide a social newsfeed of page flipping albums. Users are able to touch gesture/swipe or tap to scroll through the page flipping albums from friends, family and other contacts such as followers and people a user follows. Users are able to share, like (as commonly used in social media) or save page flipping albums. In some embodiments, a feed includes the most popular feeds for a designated area (e.g., worldwide or locally).

A user's profile is able to be customized so that it is branded to the user. The profile indicates the user's followers and those the user follows. Social networks are able to be linked to centralize the user's presence. The profile is also able to provide the user with notifications, activities and tools to edit the profile.

The art studio enables a user to generate new page flipping albums, edit existing page flipping albums and generate drafts of albums. When generating a page flipping album, the user is presented with options regarding many aspects of the page flipping album such as layout and background. The user is able to add photographs, videos, clipped content, cut and pasted content, linked content such as a video and content from another URL, images from her camera, Clipper Library, cloud storage (e.g., Dropbox) or social network pages (e.g., Facebook®). After a photograph is loaded, it is able to be edited using tools provided, such as filters, artwork (e.g., frames, shapes, text, backgrounds), colors, cropping, and any other tool. Audio/video is also able to be added to a page flipping album. The page flipping albums are able to be hyperlinked as shoppable pages to enable users to monetize their social followings. A system (e.g., the FlipClip network) is able to follow a page flipping album to the point of sale and each integral member will receive part of a commission. Page flipping albums are able to be published to social networking sites such as Facebook® and Twitter® and/or the FlipClip newsfeed.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

We claim:

1. A method programmed in a non-transitory memory of a device, the method comprising:
a. displaying a web page including at least a first section and a second section, wherein the second section comprises an inline frame, further wherein the first section includes a first content from a sharer web site, and the second section includes a second content from a merchant web site; and
b. tracking a sale through the sharer web site using code embedded within the first section of the web page.

2. The method of claim 1 wherein the web page includes a coupon input mechanism for automatically searching for a coupon using a keyword search based on an item name or a merchant name.

3. The method of claim 1 wherein the web page includes a clipping input mechanism for selecting, capturing and editing content.

4. The method of claim 3 wherein identification information is embedded within the captured content, wherein the identification information enables revenue sharing.

5. The method of claim 3 wherein the clipping input mechanism enables a user to share the edited content by text message, email or posting to a web site.

6. The method of claim 1 wherein the web page includes a search component in the first section of the web page, wherein search results from the search component are displayed in the second section of the web page.

7. The method of claim 1 wherein the code comprises javascript, and the code monitors for a purchase for revenue sharing including providing purchase information to a network.

8. A method programmed in a non-transitory memory of a device comprising:
a. selecting and capturing a plurality of images using a bookmark tool;
b. including a link with each of the plurality of images; and
c. generating an image carousel using the plurality of images and the link with each of the plurality of images.

9. The method of claim 8 wherein the plurality of images are selected and determining if a user selects an affiliate provider, and if the user selects the affiliate provider, then unique identification information is embedded with all links included with the plurality of images.

10. The method of claim 8 wherein the plurality of images are highlighted for selection individually and captured into a single image carousel.

11. The method of claim 8 wherein the plurality of images and each corresponding link are captured at the same time.

12. The method of claim 8 wherein the links include promoted content.

13. The method of claim 8 wherein the image carousel includes a flippable book, a slide show, a looping carousel, or an image iFrame.

14. A device comprising:
a. a memory configured for storing an application, the application for:
i. displaying a web page including at least a first section and a second section, wherein the second section comprises an inline frame, further wherein the first section includes a first content from a sharer web site, and the second section includes a second content from a merchant web site; and
ii. tracking a sale through the sharer web site using code embedded within the first section of the web page
b. a processor for processing the application.

15. The device of claim 14 wherein the web page includes a coupon input mechanism for automatically searching for a coupon using a keyword search based on an item name or a merchant name.

16. The device of claim 14 wherein the web page includes a clipping input mechanism for selecting, capturing and editing content.

17. The device of claim 16 wherein identification information is embedded within the captured content, wherein the identification information enables revenue sharing.

18. The device of claim 16 wherein the clipping input mechanism enables a user to share the edited content by text message, email or posting to a web site.

19. The device of claim 14 wherein the web page includes a search component in the first section of the web page, wherein search results from the search component are displayed in the second section of the web page.

20. The device of claim 14 wherein the code comprises javascript, and the code monitors for a purchase for revenue sharing including providing purchase information to a network.

21. A method programmed in a non-transitory memory of a device, the method comprising:
a. providing a platform which includes products available for purchase, product information and tools to modify the product information;
b. providing a revenue splitting scheme wherein a provider of a product agrees to receive a first specified percentage of a sale price of a product and a sponsor who finds, edits and shares the product information agrees to receive a second specified percentage of the sale price of the product; and
c. utilizing a payment gateway party for escrowing and distributing funds related to a sale of the product based on the revenue splitting scheme.

22. The method of claim 21 wherein the second specified percentage is based on a size of a social network of the sponsor.

23. The method of claim 21 wherein the revenue splitting scheme includes a sharer who shares the product information, and the sharer receives a third specified percentage of the sale price of the product.

24. The method of claim 23 wherein the first specified percentage is greater than the second specified percentage which is greater than the third specified percentage.

25. A method programmed in a non-transitory memory of a device, the method comprising:
a. sharing information of a product; and
b. receiving a percentage of a sale when the product is purchased based on the shared information, further wherein the information of the product is shared through social networking

26. The method of claim 25 wherein sharing includes sending an email.

27. The method of claim 25 wherein sharing includes posting the information on a social networking site.

28. The method of claim 25 wherein sharing includes clipping an image of the product.

29. The method of claim 25 wherein the percentage of the sale is based on a social networking queue, wherein primary sharers receive a higher percentage than secondary sharers.

30. The method of claim 25 wherein the percentage of the commissions on a sale decreases as a distance of a relationship to the sale increases.

31. A method programmed in a non-transitory memory of a device, the method comprising:
a. receiving shared information of a product; and
b. including code with the information of the product, wherein the code indicates a user and level of sharing of the user.

32. The method of claim 31 further comprising providing a percentage of a sale when the product is purchased based on the shared information, further wherein the information of the product is shared through social networking.

33. The method of claim 32 wherein the percentage of the sale is based on a social networking queue, wherein primary sharers receive a higher percentage than secondary sharers.

34. The method of claim 32 wherein the percentage of the sale decreases as a distance of a relationship to the sale increases.

35. The method of claim 31 wherein the shared information includes a clipped image of the product.

36. The method of claim 31 wherein the shared information includes a flip page book of the product.

37. The method of claim 31 wherein the shared information comprises information of a plurality of unrelated products.

38. A device comprising:
a. a memory for storing an application, the application programmed for:
i. receiving shared information of a product; and
ii. providing a percentage of a sale when the product is purchased based on the shared information, further wherein the information of the product is shared through social networking; and
b. a processor for processing the application.

39. The device of claim 38 wherein the application is further programmed for including code with the information of the product, wherein the code indicates a user and level of sharing of the user.

40. The device of claim 38 wherein the shared information includes a clipped image of the product.

41. The device of claim 38 wherein the shared information includes a flip page book of the product.

42. The device of claim 38 wherein the percentage of the sale is based on a social networking queue, wherein primary sharers receive a higher percentage than secondary sharers.

43. The device of claim 38 wherein the percentage of the sale decreases as a distance of a relationship to the sale increases.

44. The device of claim 38 wherein the shared information comprises information of a plurality of unrelated products.

45. A method programmed in a non-transitory memory of a device, the method comprising:
a. transitioning a first image to a second image by way of the second image folding over onto the first image, thus optimizing the size view of the size of images; and
b. indicating to a user via a visual indicator that there are multiple images.

46. The method of claim 45 wherein the first image and the second image are viewed on a newsfeed, wherein content groups in the news feed are in reverse chronological order.

47. A method programmed in a non-transitory memory of a device, the method comprising:
a. tracking a product as the product travels through a social network; and
b. distributing funds based on tracking the product as the travels through the social network and based on recruitment of people.

48. The method of claim 47 wherein tracking the product includes tracking users sharing information about the product.

49. The method of claim 47 wherein tracking the product includes determining if a the product is purchased, who purchased the product, and who shared information of the product leading to the sale of the product.

50. The method of claim 47 wherein the recruitment of people includes recruiting people to share information about the product.

51. The method of claim 47 wherein the recruitment of people includes recruiting people to purchase the product and is commissioned.
